(19) United States
(12) Patent Application Publication
(10) Pub. No.: US 2019/0379086 A1
(43) Pub. Date: Dec. 12, 2019

(54) LITHIUM SECONDARY BATTERY

(71) Applicant: SK INNOVATION CO., LTD., Seoul (KR)

(72) Inventors: Kyung Bin YOO, Daejeon (KR); In Haeng CHO, Daejeon (KR); Jin Haek YANG, Daejeon (KR); Duck Chul HWANG, Daejeon (KR); Joo Hyun LEE, Daejeon (KR)

(21) Appl. No.: 16/438,170

(22) Filed: Jun. 11, 2019

(30) Foreign Application Priority Data
Jun. 12, 2018 (KR) 10-2018-0067470

(51) Int. Cl. H01M 10/0567; H01M 10/0525; H01M 4/131; H01M 4/505; H01M 4/525; H01M 4/36

(52) U.S. Cl. CPC H01M 10/0567; H01M 10/0525; H01M 4/131; H01M 2004/028; H01M 4/525; H01M 4/366; H01M 4/505

(57) ABSTRACT

Provided is a lithium secondary battery. The lithium secondary battery of the present invention uses an electrolyte including the following compound, and a cathode active material including at least one metal of which a concentration at a central portion of the lithium-metal oxide particle is different from that at a surface portion of the lithium-metal oxide particle, and has improved lifetime characteristics and high temperature storage characteristics:

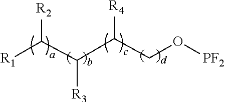

wherein R₁ is hydrogen or C1-C4alkyl, R₂ to R₄ are each independently hydrogen, C1-C4alkyl, or -OPF₂, a, b, and c are each independently an integer of 0 to 4, and d is an integer of 1 to 3, and when a, b, and c are 2 or more, R₂ to R₄ may be identical to or different from each other.

### CROSS-REFERENCE TO RELATED APPLICATIONS

This application claims priority under 35 U.S.C. § 119 to Korean Patent Application No. 10-2018-0067470, filed on Jun. 12, 2018, in the Korean Intellectual Property Office, the disclosure of which is incorporated herein by reference in its entirety.

### TECHNICAL FIELD

The following disclosure relates to a lithium secondary battery, and more particularly, to the lithium secondary battery having improved lifetime characteristics and high temperature storage characteristics.

### BACKGROUND

A cathode active material used in a battery is important for improving battery performance, and in particular, a high-capacity cathode active material is required for manufacturing a battery having high energy density and high output performance.

In order to improve battery performance and to enhance battery storage characteristics at a high temperature, through a high-capacity cathode active material, a sulfur-based additive is mainly added to an electrolyte and used. However, when a sulfur-based additive is used, a lifetime of a battery is reduced and an output performance of a battery is reduced. Accordingly, it is necessary to improve battery performance by using a high-capacity cathode active material, and at the same time to solve the problem that arises when using a sulfur-based additive.

There is an urgent need to develop a new technique capable of improving battery performance with little trade-off between output and lifetime characteristics even when using the sulfur-based additive as described above.

U.S. Patent Application Publication No. 2013/0065135, for example, discloses a lithium battery in which a specific metal element concentration is high in a portion in contact with a solid electrolyte in the lithium battery using an electrolyte containing solid sulfide. However, most of the above disclosure is aimed at improving battery performance itself, and there is no known technology for development of a cathode active material associated with overcoming the drawbacks of a lithium battery using an electrolyte containing a sulfur-based additive.

### RELATED ART DOCUMENT

### Patent Document

(Patent Document 0001) U.S. Patent Application Publication No. 2013/0065135

### SUMMARY

An embodiment of the present invention is directed to providing a lithium secondary battery having excellent lifetime characteristics and high temperature storage characteristics.

Another embodiment of the present invention is directed to providing a lithium secondary battery of which deterioration of a lifetime is suppressed and high temperature storage characteristics are excellent, even though a high-capacity cathode active material is used.

In one general aspect, a lithium secondary battery includes: a cathode, an anode, and a non-aqueous electrolyte, wherein the cathode includes a cathode active material containing a lithium-metal oxide, the electrolyte includes a lithium salt, a non-aqueous organic solvent, and a compound of the following Chemical Formula 1, and the lithium-metal oxide includes at least one metal of which a concentration at a central portion of the lithium-metal oxide particle is different from that at a surface portion of the lithium-metal oxide particle:

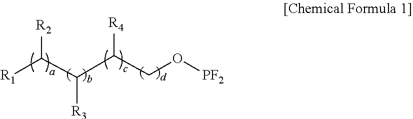

wherein R₁ is hydrogen or C₁-C₄alkyl, R₂ to R₄ are each independently hydrogen, C1-C4alkyl, or -OPF₂, a, b, and c are each independently an integer of 0 to 4, d is an integer of 1 to 3, and when a, b, and c are 2 or more, R₂ to R₄ may be identical to or different from each other.

In Chemical Formula 1 according to an exemplary embodiment of the present invention, R₁ may be hydrogen or C1-C4 alkyl, R₂ to R₄ may be each independently hydrogen or -OPF₂, and d may be an integer of 1 to 2, and more preferably R₂ may be hydrogen or -OPF₂, and R₃ and R₄ may be hydrogen.

Chemical Formula 1 according to an exemplary embodiment of the present invention may be represented by the following Chemical Formula 2:

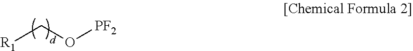

wherein R₁ is hydrogen or C1-C4alkyl, and d is an integer of 1 to 3.

Chemical Formula 1 according to an exemplary embodiment of the present invention may be represented by the following Chemical Formula 3:

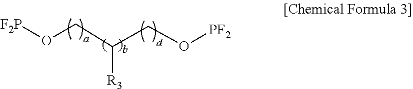

wherein R₃ is hydrogen, C1-C4alkyl, or -OPF₂, a and b are each independently an integer of 0 to 4, d is an integer of 1 to 3, and when b is 2 or more, R₃ may be identical to or different from each other.

The compound of Chemical Formula 1 according to an exemplary embodiment of the present invention may be selected from the following compounds:

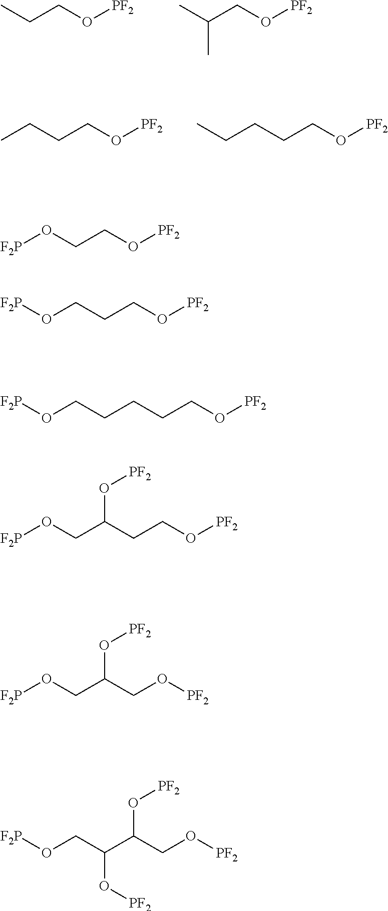

The compound of Chemical Formula 1 according to an exemplary embodiment of the present invention may be

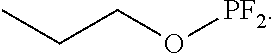

The compound of Chemical Formula 1 according to an exemplary embodiment of the present invention may be

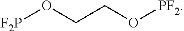

The compound of Chemical Formula 1 according to an exemplary embodiment of the present invention may be included in an amount of 0.1 to 5 wt % relative to the total weight of the electrolyte.

The electrolyte according to an exemplary embodiment of the present invention may further include any one or two or more selected from lithium bisoxalatoborate, lithium dioxalatofluorophosphate and propanesultone as additional additives. The additional additives may be included in an amount of 0.1 to 5.0 wt % relative to the total weight of the electrolyte.

The lithium-metal oxide according to an exemplary embodiment of the present invention may include any one or both of at least one first metal having a lower concentration at the surface portion of the lithium-metal oxide particle than at the central portion of the lithium-metal oxide particle and at least one third metal having a higher concentration at the surface portion of the lithium-metal oxide particle than at the central portion of the lithium-metal oxide particle.

The lithium-metal oxide according to an exemplary embodiment of the present invention may include a boundary portion between the central portion and the surface portion, and when the lithium-metal oxide includes the first metal, the concentration of the first metal at the boundary portion may be lower than that of the first metal at the central portion and/or higher than that of the first metal at the surface portion, and when the lithium-metal oxide includes the third metal, the concentration of the third metal at the boundary portion may be higher than that of the third metal at the central portion and/or lower than that of the third metal at the surface portion.

In the lithium-metal oxide according to an exemplary embodiment of the present invention, the boundary portion may include a plurality of boundary layers, the plurality of boundary layers having a concentration difference in the first metal and/or the third metal between the central portion and a boundary layer adjacent to the central portion, between two adjacent boundary layers, and/or between the surface portion and a boundary layer adjacent to the surface portion, depending on a tendency of the concentration difference in the first metal and/or the third metal between the central portion and the surface portion.

Here, a tendency of the concentration difference means a tendency that a continuous or stepwise concentration increase or decrease occurs in a predetermined section between the surface portion and the central portion. When the lithium-metal oxide according to an exemplary embodiment of the present invention includes the first metal, the first metal may include at least one metal having at least one section in which the concentration continuously decreases from the central portion of the particle toward the surface portion of the particle, and when the lithium-metal oxide according to an exemplary embodiment of the present invention includes the third metal, the third metal may include at least one metal having at least one section in which the concentration continuously increases from the central portion of the particle toward the surface portion of the particle.

The lithium-metal oxide particle according to an exemplary embodiment of the present invention may further include at least one second metal having a constant concentration throughout the particle.

The metal in the lithium-metal oxide according to an exemplary embodiment of the present invention may be any one or two or more selected from the group consisting of Ni, Co, Mn, Na, Mg, Ca, Ti, V, Cr, Cu, Zn, Ge, Sr, Ag, Ba, Zr, Nb, Mo, Al, Ga, and B.

The lithium-metal oxide according to an exemplary embodiment of the present invention may be represented by the following Chemical Formula 4:

LiₓM1ₐM2_{b}M3_{c}O_{y} [Chemical Formula 4]

wherein M1, M2, and M3 are the first metal, the second metal, and the third metal, respectively, 0<x≤1.1, 0≤a≤1, 0≤b≤1, 0≤c≤1, 0<a+b+c≤1, and y is determined so that the oxidation number of the oxide is 0, depending on the oxidation numbers of Li, M1, M2, and M3.

The lithium-metal oxide particle according to an exemplary embodiment of the present invention may include a central portion represented by Chemical Formula 5 and a surface portion represented by Chemical Formula 6:

Liₓ₁M1ₐ₁M2_{b1}M3_{c1}O_{y1} [Chemical Formula 5]

Liₓ₃M1ₐ₃M2_{b3}M3_{c3}O_{y3} [Chemical Formula 6]

wherein M1, M2, and M3 are the first metal, the second metal, and the third metal, respectively, 0<x1≤1.1, 0<x3≤1.1, 0≤a1≤1, 0≤a3≤1, 0≤b1≤1, 0≤b3≤1, 0≤c1≤1, 0≤c3≤1, 0<a1+b1+c1≤1, 0<a3+b3+c3≤1, a1≥a3, b1=b3, c1≤c3, and y1 and y3 are determined so that the oxidation number of the oxide is 0, depending on the oxidation numbers of Li, M1, M2, and M3, except that a1=a3 and c1≤c3.

The lithium-metal oxide particle according to an exemplary embodiment of the present invention may further include a boundary portion represented by Chemical Formula 7 and positioned between the central portion and the surface portion:

Liₓ₂M1ₐ₂M2_{b2}M3_{c2}O_{y2} [Chemical Formula 7]

wherein M1, M2, and M3 are the first metal, the second metal, and the third metal, respectively, 0<x2≤1.1, 0≤a2≤1, 0≤b2≤1, 0≤c2≤1, 0<a2+b2+c2≤1, a1≥a2≥a3, b1=b2=b3, c1≥c2≥c3, and y2 is determined so that the oxidation number of the oxide is 0, depending on the oxidation numbers of Li, M1, M2, and M3, except that a1=a2 and c1=c2 and that a2=a3 and c2=c3.

In the lithium-metal oxide according to an exemplary embodiment of the present invention, the first metal, the second metal, and the third metal may include Ni, Co, and Mn, respectively.

Other features and aspects will be apparent from the following detailed description, the drawings, and the claims.

### BRIEF DESCRIPTION OF THE DRAWINGS

FIG. 1 conceptually shows a cross section of a cathode active material according to an exemplary embodiment of the present invention.

FIG. 2A conceptually shows a cross section of a cathode active material according to an exemplary embodiment of the present invention, and FIG. 2B conceptually shows a cross-sectional view enlarged around a concentration gradient layer and a measurement position of a metal concentration of the cathode active material.

FIG. 3A shows a change in concentration of a first metal in a cathode active material according to an exemplary embodiment of the present invention, and FIG. 3B shows a change in concentration of a third metal in a cathode active material according to an exemplary embodiment of the present invention.

FIG. 4 is a cross-section scanning electron microscopy (SEM) image of a cathode active material prepared in Examples 3 to 14 of the present invention.

FIG. 5 is a cross-section SEM image of a cathode active material prepared in Examples 15 to 18 of the present invention.

FIG. 6 is a cross-section SEM image of a cathode active material prepared in Comparative Examples 1 to 5 of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, the present invention will be described in more detail. Technical terms and scientific terms used herein have the general meaning understood by those skilled in the art to which the present invention pertains, unless otherwise defined, and a description for the known function and configuration unnecessarily obscuring the gist of the present invention will be omitted in the following description.

The term “alkyl” used herein includes both substituted and unsubstituted linear or branched forms.

The lithium secondary battery according to an exemplary embodiment of the present invention may be a structure where electrode laminates in which a plurality of cathodes and anodes opposing each other and having a separator therebetween are stacked, are impregnated in the electrolyte.

In detail, a lithium secondary battery according to an exemplary embodiment of the present invention may include an electrode assembly in which a cathode and an anode opposing each other and having a separator therebetween are alternately stacked, an electrolyte with which the electrode assembly is impregnated, and a battery case that seals the electrode assembly and the electrolyte.

A lithium secondary battery of the present invention may include a cathode, an anode, and a non-aqueous electrolyte, wherein the cathode includes a cathode active material containing a lithium-metal oxide, the electrolyte includes a lithium salt, a non-aqueous organic solvent, and a compound of the following Chemical Formula 1, and the lithium-metal oxide includes at least one metal of which a concentration at a central portion of the lithium-metal oxide particle is different from that at a surface portion of the lithium-metal oxide particle:

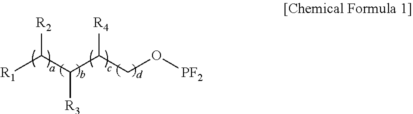

wherein R₁ is hydrogen or C1-C4alkyl, R₂ to R₄ are each independently hydrogen, C1-C4alkyl, or -OPF₂, a, b, and c are each independently an integer of 0 to 4, d is an integer of 1 to 3, and when a, b, and c are 2 or more, R₂ to R₄ may be identical to or different from, each other.

A central portion of the lithium-metal oxide particle herein means a portion having the same metal concentration or composition contained in the lithium-metal oxide particle from the center of the lithium-metal oxide particle toward the surface thereof, and a surface portion means a portion having the same metal concentration or composition contained in the lithium-metal oxide particle from the outermost surface of the lithium-metal oxide particle toward the center thereof. Here, the central portion may typically be a sphere-type. However, a type of the central portion is not limited thereto, and may be a polygonal-type. The metal may be one or two or more types, and at least one metal between the central portion and the surface portion has a difference in concentration or composition.

A constant concentration or composition herein means concentration or composition falling within the tolerances allowed in the art to which the present invention pertains. For example, it can be regarded as a constant concentration or composition when a difference in the molar ratio of the metals contained in the lithium-metal oxide particle, which is a cathode active material included in the lithium secondary battery herein, is within 2%, more preferably within 1%, and more preferably within 0.5% relative to the total molar ratio of the metal.

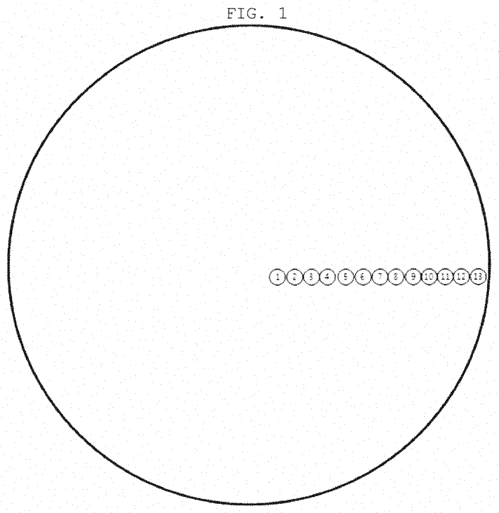

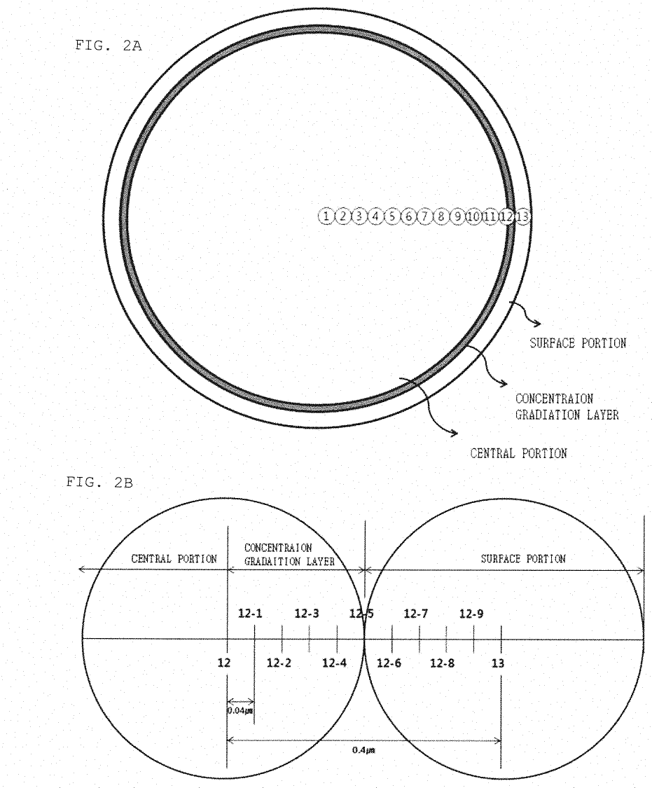

The shape of the cathode active material included in the lithium secondary battery of the present invention will be described in more detail with reference to FIGS. 1 and 2. FIG. 1 is a view conceptually showing a cross section of a cathode active material particle of the present invention, which is expressed by dividing the zone from No. 1 to No. 13 from a center to the outermost surface, depending on the measurement position and range of the concentration. The zone marked with No. 1 is the center of the particle, and the zone marked with No. 13 contacts the outermost surface of the particle. The numerals as shown in FIGS. 1 and 2 are only arbitrarily described for dividing the central portion and the surface portion, and the present invention is not limited thereto. In addition, the central portion or the surface portion is not limited to the zone corresponding to only one number. In FIG. 1, for example, a section No. 1 to No. 12 may be the central portion, and a section No. 2 to No. 13 may be the surface portion. Alternatively, as in the case where No. 1 is the central portion and a section No. 2 to No. 13 is the surface portion, a section No. 1 to No. 2 is the central portion and a section No. 3 to No. 13 is the surface portion, a section No. 1 to No. 11 is the central portion and a section No. 12 to No. 13 is the surface portion, or a section No. 1 to No. 12 is the central portion and No. 13 is the surface portion, the central portion and the surface portion are distinguished, and a difference in concentration of the metal occurs between the central portion and the surface portion. This is also the same when a boundary portion is included between the central portion and the surface portion. Non-limiting examples of the lithium secondary battery according to an exemplary embodiment of the present invention include a lithium metal secondary battery, a lithium ion secondary battery, a lithium polymer secondary battery, or a lithium ion polymer secondary battery, or the like.

The secondary battery electrolyte according to an exemplary embodiment of the present invention contains a compound of Chemical Formula 1, more specifically, a compound of Chemical Formula 1 having an -OPF₂ substituent. The lithium secondary battery containing such an electrolyte has remarkably improved lifetime characteristics and has a low rate of change in thickness of the battery at a high temperature, and thus has excellent high temperature storage characteristics.

More specifically, the compound of Chemical Formula 1 according to an exemplary embodiment of the present invention is decomposed at the anode while lowering the resistance of the battery under high voltage to form an SEI coating more efficiently, thereby remarkably improving high temperature characteristics and lifetime characteristics.

In addition, the lithium secondary battery of the present invention, which includes a lithium salt, a non-aqueous organic solvent, a compound of Chemical Formula 1, and a cathode active material containing a lithium-metal oxide including at least one metal of which a concentration at the central portion of the lithium-metal oxide particle is different from that at the surface portion of the lithium-metal oxide particle, has more excellent lifetime characteristics and high temperature storage characteristics, as compared to the lithium secondary battery which does not include a metal of which a concentration at the central portion of the lithium-metal oxide particle is different from that at the surface portion of the lithium-metal oxide particle.

In terms of chemical stability and electrical characteristics, preferably in Chemical Formula 1 according to an exemplary embodiment of the present invention, R₁ may be hydrogen or C1-C4alkyl, R₂ to R₄ may be each independently hydrogen or -OPF₂, and d may be an integer of 1 to 2, and more preferably, R₂ may be hydrogen or -OPF₂, and R₃ and R₄ may be hydrogen.

Preferably, Chemical Formula 1 according to an exemplary embodiment of the present invention may be represented by the following Chemical Formula 2:

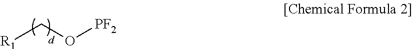

wherein R₁ is hydrogen or C1-C4alkyl, and d is an integer of 1 to 3.

In terms of an excellent capacity retention rate and a high temperature storage stability, preferably, Chemical Formula 1 according to an exemplary embodiment of the present invention may be represented by the following Chemical Formula 3:

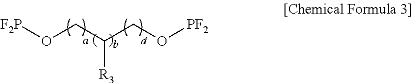

wherein R₃ is hydrogen, C1-C4alkyl, or -OPF₂, a and b are each independently an integer of 0 to 4, d is an integer of 1 to 3, and when b is 2 or more, R₃ may be identical to or different from each other.

Preferably, in Chemical Formulas 2 and 3, R₁ may be C1-C4alkyl, R₃ may be hydrogen or -OPF₂, a and b may be each independently an integer of 0 to 4, d may be an integer of 1 to 2, and when b is 2 or more, R₃ may be identical to or different from each other, and more preferably, R₃ may be hydrogen.

Preferably, the compound of Chemical Formula 1 according to an exemplary embodiment of the present invention may be selected from the following structural formulas, but is not limited thereto.

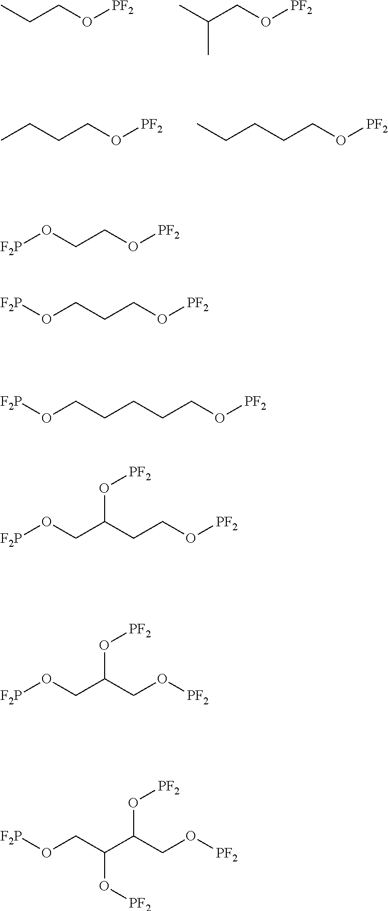

The compound of Chemical Formula 1 according to an exemplary embodiment of the present invention may be

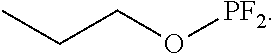

The compound of Chemical Formula 1 according to an exemplary embodiment of the present invention may be

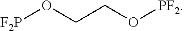

In the electrolyte of the secondary battery according to an exemplary embodiment of the present invention, the compound of Chemical Formula 1 may be included in an amount of 0.1 to 5 wt % relative to the total weight of the electrolyte, in terms of improving a high temperature stability and capacity retention rate and preventing deterioration of characteristics of the secondary battery due to occurrence of rapid deterioration in the lifetime, or the like, and more preferably in an amount of 0.5 to 3 wt %, even more preferably 1.0 to 2.5 wt %, and still more preferably in an amount of 1.0 to 1.5 wt % relative to the total weight of the electrolyte, in terms of a high temperature stability.

The electrolyte of the secondary battery according to an exemplary embodiment of the present invention may further include additional additives to improve battery lifetime and a high temperature storage stability.

The electrolyte of the secondary battery according to an exemplary embodiment of the present invention may further include any one or two or more selected from lithium bisoxalatoborate, lithium dioxalatofluorophosphate, and propanesultone as specific additional additives.

Preferably, the electrolyte of the lithium secondary battery according to an exemplary embodiment of the present invention may further include lithium bisoxalatoborate, lithium dioxalatofluorophosphate, and propanesultone as additional additives.

In the electrolyte of the lithium secondary battery according to an exemplary embodiment of the present invention, the content of the additional additives is not particularly limited, but may be included in an amount of 0.1 to 5 wt %, preferably 0.5 to 3 wt %, and more preferably 1 to 3 wt %, relative to the total weight of the electrolyte, for a prevention of a deterioration in battery output, an improvement in storage characteristics, an improvement in battery lifetime, or the like.

In the electrolyte of the lithium secondary battery according to an exemplary embodiment of the present invention, examples of the non-aqueous organic solvent may include carbonate, ester, ether, or ketone alone or a mixed solvent thereof. It is preferable that the non-aqueous organic solvent is selected from a cyclic carbonate-based solvent, a linear carbonate-based solvent, and a mixed solvent thereof. It is most preferable to use a mixed solvent of a cyclic carbonate-based solvent and a linear carbonate-based solvent. The cyclic carbonate-based solvent has a high polarity, which can sufficiently dissociate lithium ions, but has a disadvantage in that, the ion conductivity is low due to a high viscosity. Therefore, the characteristics of the lithium secondary battery may be optimized by using a mixed solvent of the cyclic carbonate-based solvent and a linear carbonate-based solvent having a low polarity but a low viscosity.

The cyclic carbonate-based solvent may be selected from the group consisting of ethylene carbonate, propylene carbonate, butylene carbonate, vinylene carbonate, vinylethylene carbonate, fluorethylene carbonate, and a mixture thereof. The linear carbonate-based solvent may be selected from the group consisting of dimethyl carbonate, diethyl carbonate, dipropyl carbonate, ethyl methyl carbonate, methyl propyl carbonate, methyl isopropyl carbonate, ethyl propyl carbonate, and a mixture thereof.

In the electrolyte of the secondary battery according to an exemplary embodiment of the present invention, the non-aqueous organic solvent may be a mixed solvent of the cyclic carbonate-based solvent and the linear carbonate-based solvent, and may be used by mixing the linear carbonate-based solvent:the cyclic carbonate-based solvent in a ratio of 1 to 9:1, and preferably 1.5 to 4:1 by volume.

In the electrolyte of the secondary battery according to an exemplary embodiment of the present invention, the lithium salt may be one or two or more selected from, the group consisting of LiPF₆, LiBF₄, LiClO₄, LiSbF₆, LiAsF₆, LiN (SO₂C₂F₅)₂, LiN (CF₃SO₂)₂, LiN (SO₃C₂F₅)₂, LiN (SO₂F)₂, LiCF₃SO₃, LiC₄F₉SO₃, LiC₆H₅SO₃, LiSCN, LiAlO₂, LiAlCl₄, LiN (CₓF₂ₓ₊₁SO₂) (C_{y}F_{2y+1}SO₂) (wherein x and y are natural numbers), LiCl, LiI and LiB (C₂O₄)₂, but is not limited thereto.

The concentration of the lithium salt is used preferably in the range of 0.1 to 2.0 M, more preferably in the range of 0.7 to 1.6 M, and still more preferably in the range of 0.7 to 1.0 M. When the concentration of the lithium salt is less than 0.1 M, the conductivity of the electrolyte decreases, thereby deteriorating performance of the electrolyte. When the concentration of the lithium salt exceeds 2.0 M, the viscosity of the electrolyte increases, thereby decreasing mobility of the lithium ion. The lithium salt serves as a source of the lithium ion in the battery, thereby enabling operation of a basic lithium secondary battery.

The cathode according to an exemplary embodiment of the present invention may include a cathode active material containing a lithium-metal oxide, and the lithium-metal oxide may include at least one metal of which a concentration at a central portion of the lithium-metal oxide particle is different from that at a surface portion of the lithium-metal oxide particle.

The lithium-metal oxide according to an exemplary embodiment of the present invention may include any one or both of at least one first metal having a lower concentration at the surface portion of the lithium-metal oxide particle than at the central portion of the lithium-metal oxide particle and at least one third metal having a higher concentration at the surface portion of the lithium-metal oxide particle than at the central portion of the lithium-metal oxide particle.

The lithium-metal oxide particle according to an exemplary embodiment of the present invention may further include at least one second metal having a constant concentration throughout the particle.

The lithium-metal oxide according to an exemplary embodiment of the present invention may be represented by the following Chemical Formula 4:

LiₓM1ₐM2_{b}M3_{c}O_{y} [Chemical Formula 4]

wherein M1, M2, and M3 are the first metal, the second metal, and the third metal, respectively, 0−x≤1.1, 0≤a≤1, 0≤b≤1, 0≤c≤1, 0<a+b+c≤1, and y is determined so that the oxidation number of the oxide is 0, depending on the oxidation numbers of Li, M1, M2, and M3.

The concentration range of the metal in the lithium-metal oxide particle used in the present invention may be adjusted depending on characteristics such as capacity, lifetime, safety, output, or the like of the active material.

According to an exemplary embodiment of the present invention, in Chemical Formula 4, the range of a may be 0.60≤a≤0.95, preferably 0.70≤a≤0.90, more preferably, 0.75≤a≤0.90, and still more preferably, 0.80≤a≤0.88, but is not limited thereto.

According to another exemplary embodiment of the present invention, in Chemical Formula 4, the range of c ma y be 0≤c1≤0.3, preferably 0≤c1≤0.2, more preferably, 0.001≤c≤0.140, still more preferably, 0.002≤c≤0.120, even more preferably 0.003≤c≤0.110, and even still more preferably 0.003≤c≤0.100, but is not limited thereto.

According to still another exemplary embodiment of the present invention, in Chemical Formula 4, the range of b+c may be 0.05≤b+c≤0.40, preferably 0.05≤b+c≤0.30, more preferably, 0.10≤b+c≤0.30, still more preferably, 0.15≤b+c≤0.25, and even more preferably 0.12≥b+c≥0.20, but is not limited thereto.

The lithium-metal oxide particle according to an exemplary embodiment of the present invention may include a central portion represented by Chemical Formula 5 and a surface portion represented by Chemical Formula 6:

Liₓ₁M1ₐ₁M2_{b1}M3_{c1}O_{y1} [Chemical Formula 5]

Liₓ₃M1ₐ₃M2_{b3}M3_{c3}O_{y3} [Chemical Formula 6]

wherein M1, M2, and M3 are the first metal, the second metal, and the third metal, respectively, 0<x1≤1.1, 0<x3≤1.1, 0≤a1≤1, 0≤a3≤1, 0≤b1≤, 0≤b3≤1, 0≤c1≤1, 0≤c3≤1, 0<a1+b1+c1≤1, 0<a3+b3+c3≤1, a1≥a3, b1=b3, c1≤c3, and y1 and y3 are determined so that the oxidation number of the oxide is 0, depending on the oxidation numbers of Li, M1, M2, and M3, except that a1=a3 and c1=c3.

The lithium-metal oxide particle according to an exemplary embodiment of the present invention may have a1 of 0.6 or more, preferably 0.7 or more, more preferably 0.8 or more, and still more preferably 0.83 or more in Chemical Formula 5.

The lithium-metal oxide particle according to an exemplary embodiment of the present invention may have c1 of 0.3 or less, preferably of 0.2 or less, more preferably of 0.1 or less, and still more preferably of 0.07 or less in Chemical Formula 5.

The lithium-metal oxide particle according to an exemplary embodiment of the present invention may have a3 of 0.6 or more, preferably 0.7 or more, and more preferably 0.78 or more in Chemical Formula 6.

The lithium-metal oxide particle according to an exemplary embodiment of the present invention may have c3 of 0.3 or less, preferably of 0.2 or less, and more preferably of 0.12 or less in Chemical Formula 6.

The lithium-metal oxide particle according to an exemplary embodiment of the present, invention may include the boundary portion between the central portion and the surface portion, and when the lithium-metal oxide particle includes the first metal, the concentration of the first metal at the boundary portion may be lower than that of the first metal at the central portion and/or may be higher than that of the first metal at the surface portion, and when the lithium-metal oxide particle includes the third metal, the concentration of the third metal at the boundary portion may be higher than that of the third metal at the central portion and/or may be lower than that of the third metal at the surface portion.

The lithium-metal oxide particle according to an exemplary embodiment of the present invention may further include a boundary portion represented by Chemical Formula 7 and positioned between the central portion and the surface portion:

Liₓ₂M1ₐ₂M2_{b2}M3_{c2}O_{y2} [Chemical Formula 7]

wherein M1, M2, and M3 are the first metal, the second metal, and the third metal, respectively, 0<x2≤1.1, 0≤a2≤1, 0≤b2≤1, 0≤c2≤1, 0≤a2+b2+c2≤1, a1≥a2≥a3, b1=b2=b3, c1≥c2≥c3, and y2 is determined so that the oxidation number of the oxide is 0, depending on the oxidation numbers of Li, M1, M2, and M3, except that a1=a2 and c1=c2 and that a2=a3 and c2=c3.

The lithium-metal oxide particle according to another exemplary embodiment of the present invention may have 0.7≤a2≤0.9, preferably 0.75≤a2≤0.85, and more preferably 0.78≤a2≤0.83 in Chemical Formula 7.

The lithium-metal oxide particle according to another exemplary embodiment of the present, invention may have 0.05≤c2≤0.15, preferably 0.07≤a2≤0.12, and more preferably 0.09≤a2≤0.11 in Chemical Formula 7.

The lithium-metal oxide particle according to an exemplary embodiment of the present invention may have a difference in molar ratio of the metal between the central portion and the surface portion of 0.01|a1−a3|≤0.20, preferably 0.01≤|a1−a3|≤0.10, more preferably 0.02≤|a1−a3|≤0.075, and still more preferably 0.03≤|a1−a3|≤0.05 in Chemical Formulas 5 and 6.

The lithium-metal oxide particle according to an exemplary embodiment of the present invention may have a difference in molar ratio of the metal between the central portion and an interface portion and between the interface portion and the surface portion of 0.01≤|a1−a2|≤0.10 and 0.01≤|a2−a3|≤0.10, respectively, preferably 0.02≤|a1−a2 |≤0.75 and 0.02≤|a2−a3|≤0.75, and more preferably 0.03≤|a1−a2|≤0.05 and 0.03≤|a2−a3|≤0.05, respectively, in Chemical Formula 7.

The range of difference in molar ratio of the metal between the central portion and the surface portion described above is within the above-mentioned range, whereby generation of impurities that can be caused by a rapid difference in composition of the metal may be suppressed, and lifetime and high temperature storage characteristics of the manufactured lithium secondary battery may be further improved. In the lithium-metal oxide according to an exemplary embodiment of the present invention, the boundary portion may include a plurality of boundary layers, the plurality of boundary layers having a concentration difference in the first metal and/or the third metal between the central portion and a boundary layer adjacent to the central portion, between two adjacent boundary layers, and/or between the surface portion and a boundary layer adjacent to the surface portion, depending on a tendency of the concentration difference in the first metal and/or the third metal between the central portion and the surface portion.

In the lithium-metal oxide according to an exemplary embodiment of the present invention, the first metal may include at least one metal having at least one concentration gradient section in which the concentration continuously decreases from the center of the particle toward the surface of the particle, and the third metal may include at least one metal having at least one concentration gradient section in which the concentration continuously increases from the center of the particle toward the surface of the particle.

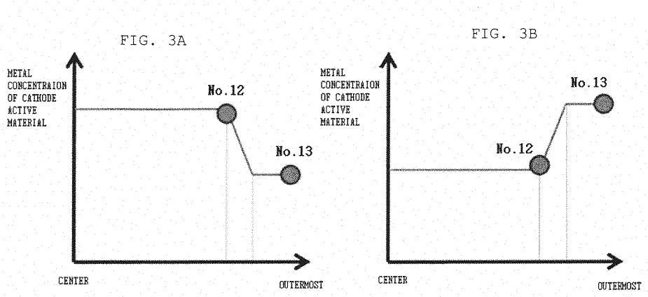

More specifically, according to an exemplary embodiment of the present invention, in the particle as shown in FIGS. 2 and 3, in the case where the central portion is from the center of No. 1 to the center of No. 12, the concentration gradient is formed in a portion between the central portion of No. 12 and the center of No. 13, and the surface portion is a portion from the end of the concentration gradient in the portion of No. 12, to No. 13, they may be shown as in FIGS. 2 and 3. In the section of the concentration gradient, a concentration gradient of one or more metals contained in the lithium-metal oxide particle, which is the cathode active material, may be formed. A description for the cathode active material referring to FIGS. 2 and 3 above is only for assisting in the understanding of the present invention. Therefore, the present invention is not construed as being limited thereto.

According to an exemplary embodiment of the present invention, when the range in which the concentration gradient of the first metal is formed, is 0.78 to 0.83 and the range in which the concentration gradient of the third metal is formed, is 0.07 to 0.12, a rapid concentration gradient may not be formed between the central portion and the surface portion, the cathode active material may be structurally stable, and the effect of high temperature storage characteristics by addition of the compound of Chemical Formula 1 in the lithium secondary battery may be more excellent.

The metal of the lithium-metal oxide according to an exemplary embodiment of the present invention is not limited as long as it is used in a lithium secondary battery, and may be any one or two or more selected from the group consisting of Ni, Co, Mn, Na, Mg, Ca, Ti, V, Cr, Cu, Zn, Ge, Sr, Ag, Ba, Zr, Nb, Mo, Al, Ga, and B.

In the lithium-metal oxide according to an exemplary embodiment of the present invention, the first metal, the second metal, and the third metal may include Ni, Co, and Mn, respectively.

The lithium-metal oxide particle according to an exemplary embodiment of the present invention may be any one or both of a sphere-type and a rod-type.

More specifically, in Chemical Formulas 4 to 7 according to an exemplary embodiment of the present invention, M1 may be Ni, M2 may be Co, and M3 may be Mn. Ni, Co, and Mn are used as the metal for the cathode active material containing the lithium-metal oxide, and the composition ratio thereof is adjusted, thereby suppressing over-discharge of the lithium secondary battery manufactured and suppressing the generation of impurities such as lithium hydroxide (LiOH) and lithium carbonate (Li₂O₃). As a result, capacity, lifetime, and high temperature storage characteristics of the battery may be improved.

More specifically, the metal contained in the lithium-metal oxide may have a continuous concentration gradient from the central portion toward the surface portion by adjusting the molar ratio of M1 to M3 in Chemical formulas 4 to 7 according to an exemplary embodiment of the present invention.

Particularly, in Chemical Formulas 4 to 7 according to an exemplary embodiment of the present invention, when M1 may be Ni, M2 may be Co, and M3 may be Mn, the molar ratio of M1 may be decreased from the central portion toward the surface portion, and the molar ratio of M3 may be increased from the central portion toward the surface portion. That is, the molar ratio of Co as M2 may be fixed, the content of Mn may be gradually increased from, the central portion, while gradually decreasing the content of Ni from the central portion, and the molar ratio of total-metals may be fixed at a constant range.

In addition, the lithium-metal oxide particle according to an exemplary embodiment of the present invention may adjust the thickness of the boundary portion and the surface portion by adjusting the retention time, temperature, and rotation speed in the reactor in preparing the surface portion, or the boundary portion and the surface portion. More specifically, L may be defined as a radius of the entire lithium-metal oxide particle, Li may be defined as a distance from the center of the lithium-metal oxide particle to the boundary between the central portion and an outer side of the central portion (i.e., the surface portion or the boundary portion), L₃ may be defined as a distance from the surface to the boundary between the surface portion and an inner side of the surface portion (i.e., the central portion or the boundary portion), and L₂ may be defined as a distance from the boundary between the central portion and an outer side of the central portion to a section between the surface portion and the inner side of the surface portion. Here, in the lithium-metal oxide particle according to an exemplary embodiment of the present invention, L₁/L may be 0.1 or more, 0.15 or more, 0.2 or more, 0.25 or more, or 0.5 or more, and may be 0.99 or less, 0.9 or less, 0.8 or less, 0.7 or less, or 0.6 or less.

In addition, in the lithium-metal oxide particle according to an exemplary embodiment of the present invention, L₃/L may be 0.05 or more, 0.1 or more, 0.2 or more, 0.3 or more, 0.4 or more, 0.5 or more, and may be 0.9 or less, 0.8 or less, 0.7 or less, 0.6 or less, or 0.5 or less.

in addition, in the lithium-metal oxide particle according to an exemplary embodiment of the present invention, L₂/L may be 0.01 or more, 0.05 or more, or 0.1 or more, and may be 0.5 or less, 0.4 or less, 0.3 or less, or 0.2 or less.

L₁/L, L₂/L, and L₃/L described above represent also a difference in metal concentration of the lithium-metal oxide particle as the thickness ratio of each portion. That is, the concentration gradient of the metal from the center toward the surface may be adjusted by adjustment of the thickness of the central portion, the boundary portion, and the surface portion, thereby suppressing generation of impurities such as carbonate and hydroxide of the metal that can be generated when the concentration of the metal on the surface portion is excessively high, and suppressing a rapid change in concentrations of the central portion and the surface portion to improve the structural stability of the cathode active material. In an exemplary embodiment of the present invention, an anode active material of each anode in an electrode assembly may be any active material conventionally used for an anode of a lithium secondary battery. As an example of the lithium secondary battery, the anode active material may be any material capable of lithium intercalation. As the anode active material, carbon materials such as crystalline carbon, amorphous carbon, carbon composite, carbon fiber, or the like, lithium metal, an alloy of lithium and other elements, or the like may be used. As non-limiting examples, the anode active material may be at least one selected from the group consisting of lithium (lithium metal), easy-graphitizable carbon, non-graphitizable carbon, graphite, silicon, Li alloy, Sn alloy, Si alloy, Sn oxide, Si oxide, Ti oxide, Ni oxide, Fe oxide (FeO) and Lithium-titanium oxide (LiTiO₂, Li₄Ti₅O₁₂).

As non-limiting examples, noncrystalline carbon may be hard carbon, coke, mesocarbon microbeads (MCMB) calcined at 1500° C. or less, mesophase pitch-based carbon fiber (MPCF), or the like. Crystalline carbon may be graphite-based material, specifically, may be natural graphite, graphitized coke, graphitized MCMB, graphitized MPCF, or the like. The carbonaceous material is preferably a material having an interplanar distance of 3.35 to 3.38 Å and a crystallite size (Lc) of at least 20 nm or more by X-ray diffraction. As non-limiting examples of another element for forming the alloy with lithium, aluminum, zinc, bismuth, cadmium., antimony, silicon, lead, tin, gallium, or indium may be used.

In an exemplary embodiment of the present invention, the anode active material may be a composite of at least two or more materials (a first anode active material and a second anode active material) selected from the group of the anode active material. The composite may have a structure where the first anode active material and the second anode active material are simply mixed, a core-shell structure which is a core of the first anode active material-a shell of the second, anode active material, a structure where the second anode active material is supported on a matrix of the first anode active material, a structure where the second anode active material is coated or supported on the first anode active material having 0-, 1- and 2-dimensional nanostructures, or a structure where the first anode active material and the second anode active material are stacked.

The respective cathodes of the electrode assembly may be connected with each other in series, in parallel, or in series and parallel, and the respective anodes of the electrode assembly may also be connected with each other in series, in parallel, or in series and parallel. Here, the cathode may include a current collector and a cathode active material layer containing the cathode active material on the current collector. The cathode may include a non-coated portion in which the cathode active material layer is not formed on the current collector. The anode may also include a current collector and an anode active material layer containing the anode active material on the current collector. The anode may include a non-coated portion on which the anode active material layer is not formed. An electrical connection between the respective cathodes or between the respective anodes of the electrode assembly may be performed through the non-coated portion.

Respective cathode current collectors and/or respective anode current collectors of the electrode assembly may be a porous conductor. More specifically, the current collector may be in the form of a foam, a film, a mesh, a felt or a perforated film, of conductive materials. Still more specifically, as the current collector, a conductive material containing graphite, graphene, titanium, copper, platinum., aluminum, nickel, silver, gold, or carbon nanotubes with excellent conductivity and chemically stable during charging/discharging of the battery, may be used. As the cathode current collector, aluminum or an aluminum alloy may often be used, and as the anode current collector, copper or a copper alloy may often be used. The current collector may be in the form of a foam, a film, a mesh, a felt, or a perforated film of conductive materials, and may be a composite coated or stacked with different conductive materials.

The cathode or anode may be manufactured by dispersing an electrode active material, a binder and a conductive material, and if necessary, a thickener in a solvent to prepare an electrode slurry composition, and applying the slurry composition to an electrode current collector.

A binder serves to paste the active material, mutual adhesion, of the active material, adhesion with the current collector, a buffering effect on expansion and contraction of the active material, or the like. For example, the binder may include polyvinylidene fluoride (PVdF), a copolymer of polyhexafluoropropylene-polyvinylidene fluoride (HFP/PVdF), poly(vinyl acetate), polyvinyl alcohol, polyethylene oxide, polyvinyl pyrrolidone, alkylated polyethylene oxide, polyvinyl ether, poly(methyl methacrylate), poly(ethyl acrylate), polytetrafluoroethylene, polyvinyl chloride, polyacrylonitrile, polyvinylpyridine, styrene-butadiene rubber, acrylonitrile-butadiene rubber, or the like. The content of the binder is 0.1 to 30 wt %, preferably 1 to 10 wt %, relative to the electrode active material. When the content of the binder is excessively small, adhesion between the electrode active material and the current collector is insufficient. Meanwhile, when the content of the binder is excessively large, adhesion is improved but the content of the electrode active material is reduced accordingly, which is disadvantageous for increasing the battery capacity.

A conductive material is used for imparting conductivity to the electrode, and may be any material as long as it is an electro conductive material without causing any chemical change in the battery constituted. As the conductive material, at least one selected from the group consisting of a graphite-based conductive material, a carbon black-based conductive material, and a metal-based or metal compound-based conductive material may be used. Examples of the graphite-based conductive material include artificial graphite, natural graphite, or the like. Examples of the carbon black-based conductive material include acetylene black, ketjen black, denka black, thermal black, channel black, or the like. Examples of the metal-based or metal compound-based conductive material include perovskite materials such as tin, tin oxide, tin phosphate (SnPO₄), titanium oxide, potassium titanate, LaSrCoO₃, and LaSrMnO₃. However, the conductive material is not limited to the above-mentioned materials.

The content of the conductive material is preferably 0.1 to 10 wt %, relative to the electrode active material. When the content of the conductive material is smaller than 0.1 wt %, relative to the electrode active material, electrochemical characteristics are deteriorated, and when the content of the conductive material exceeds 10 wt %, relative to the electrode active material, an energy density per weight is decreased.

The thickener is not particularly limited as long as it can adjust the viscosity of an active material slurry. For example, as the thickener, carboxymethyl cellulose, hydroxymethyl cellulose, hydroxyethyl cellulose, hydroxypropyl cellulose, or the like, may be used.

As the solvent in which the electrode active material, the binder, the conductive material, or the like are dispersed, a non-aqueous solvent or an aqueous solvent is used. Examples of the non-aqueous solvent may include N-methyl-2-pyrrolidone (NMP), dimethylformamide, dimethylacetamide, N,N-dimethylaminopropylamine, ethylene oxide, tetrahydrofuran, or the like.

The lithium secondary battery of the present invention may include a separator which prevents a short-circuit between the cathode and the anode and provides a passage for the lithium ion. As the separator, a membrane of polyolefin-based polymer such as polypropylene, polyethylene, polyethylene/polypropylene, polyethylene/polypropylene/polyethylene, or polypropylene/polyethylene/polypropylene, or a multi-membrane thereof, a microporous film, woven fabrics, or nonwoven fabrics may be used. In addition, a film coated with a resin having excellent stability may be used as a porous polyolefin film. Here, the separator may be coated with an inorganic material, and may also have a stacked structure where a plurality of organic membranes such as a polyethylene film, a polypropylene film, a nonwoven fabric are stacked, in order to improve the overcurrent prevention function, the electrolyte maintenance function, and the physical strength.

In an exemplary embodiment of the present invention, the lithium secondary battery may have a shape of a square, a cylinder, a pouch, or the like.

In an exemplary embodiment of the present invention, the electrode assembly may be manufactured by a conventional method of manufacturing a jelly roll-type electrode assembly. As an example, the electrode assembly may be formed by rolling a plurality of cathodes and anodes alternately spaced apart from each other on one surface of the separator. However, the present invention may not be limited to the method of manufacturing the electrode assembly described above.

Hereinafter, the present invention will be described in more detail through a method of manufacturing the cathode active material according to an exemplary embodiment, in the present invention.

In detail, the method of manufacturing the cathode active material containing a lithium-metal oxide according to an exemplary embodiment of the present invention may include: a) a step of simultaneously mixing a lithium raw material, at least one metal raw material, a chelating agent, and a basic aqueous solution, and then calcining the mixture to prepare a central portion; b) a step of simultaneously mixing a lithium raw material, at least one metal raw material, a chelating agent, and a basic aqueous solution, and then calcining and pulverizing the mixture to be nanosize to prepare a compound for forming a surface portion; c) a step of mixing the central portion obtained from the step a) and the compound for forming the surface portion obtained from, the step b) to form a surface portion on the surface of the central portion; and d) a step of subjecting the compound obtained from the step c) to heat treatment to form a structure where a section having a different metal concentration is present between the central portion and the surface portion.

In addition, when a structure of the lithium-metal oxide according to an exemplary embodiment of the present invention includes a first central portion, a second central portion, and the surface portion, the method of manufacturing the cathode active material may include: a) a step of simultaneously mixing a lithium raw material, at least, one metal raw material, a chelating agent, and a basic aqueous solution, and then calcining the mixture to prepare a first central portion; b) a step of simultaneously mixing a lithium raw material, at least one metal raw material, a chelating agent, and a basic aqueous solution, and then calcining and pulverizing the mixture to be nanosize to prepare a compound for forming the second central portion; c) a step of simultaneously mixing a lithium raw material, at least one metal raw material, a chelating agent, and a basic aqueous solution, and then calcining and pulverizing the mixture to be nanosize to prepare a compound for forming the surface portion; d) a step of mixing the first central portion obtained from the step a) and the compound for forming the second central portion obtained from the step b) to form the second central portion on the surface of the first central portion; e) a step of mixing the compound obtained from the step d) and the compound for forming the surface portion obtained from the step c) to form the surface portion on the surface of the second central portion; and f) a step of subjecting the compound obtained from the step e) to heat treatment to form a structure where a section having a different metal concentration is present among the first central portion, the second central portion and the surface portion.

When the lithium-metal oxide according to an exemplary embodiment of the present invention has a structure of the central portion and the surface portion, first, in the step a), the central portion may be prepared by simultaneously mixing a lithium raw material, at least one metal raw material, a chelating agent, and a basic aqueous solution, and then calcining the resulting mixture.

In an exemplary embodiment of the present invention, the lithium raw material is not limited to any kind as long as it is a material commonly used in the production of the cathode active material, or the like in the art. The lithium raw material is not particularly limited as long as it is a lithium salt such as lithium carbonate and lithium nitrate, for example.

In an exemplary embodiment of the present invention, examples of the metal raw material may include a metal salt of at least one element selected the group consisting of nickel (Ni), cobalt (Co), manganese (Mn), iron (Fe), sodium (Na), calcium (Ca), titanium (Ti), vanadium (V), chromium (Cr), copper (Cu), zinc (Zn), germanium (Ge), strontium (Sr), silver (Ag), barium (Ba), zirconium (Zr), niobium (Nb), molybdenum (Mo), aluminum (Al), gallium (Ga), boron (B), and a combination thereof. In addition, as the metal salt, sulfate, nitrate, acetate, halide, hydroxide, or the like may be used. The metal salt is not particularly limited as long as it is capable of dissolving in a solvent. As the chelating agent used in an exemplary embodiment of the present invention, an aqueous ammonia solution, an aqueous ammonium sulfate solution, or a mixture thereof may be used. The molar ratio of the chelating agent to the metal raw material may be 0.1 to 0.5:1, but the present invention is not limited thereto.

In an exemplary embodiment of the present invention, examples of a basic aqueous solution used may include, but is not limited to, sodium hydroxide, potassium hydroxide, or the like. The basic aqueous solution is not limited as long as it is a basic material which may be usually used in the production of the active material. In addition, the concentration of the basic aqueous solution may be 1 to 5 M, but the present invention is not limited thereto.

In an exemplary embodiment of the present invention, a co-precipitation method may be applied in the step a). In more detail, one or more metal salts are dissolved in a solvent such as distilled water, and then continuously added into each reactor, together with a chelating agent and a basic aqueous solution to cause precipitation. Here, in the reactor, average residence time of the metal salt solution may be adjusted to 2 to 12 hours, pH may be adjusted to 10 to 12.5, and preferably 10.5 to 11.5, and the reactor temperature may be adjusted to 50 to 100° C. In addition, in the reactor, the reaction time may be adjusted to 5 to 40 hours, and preferably 10 to 30 hours. However, these conditions may be freely changed depending on a composition of the raw material, a composition ratio, or the like, but the present invention is not limited thereto.

The central portion may be prepared by collecting a precipitate prepared through the reactor in a slurry form, filtering, washing and drying the resulting slurry solution to obtain a metal oxide, and then mixing the resulting mixture with a lithium raw material at a certain ratio, followed by calcining at 700 to 1,000° C. under an air flow. The ratio of the lithium raw material and the metal oxide thus prepared is not limited, but is preferably 1:1 by weight.

Next, in the step b), the compound for forming the surface portion may be prepared by simultaneously mixing a lithium raw material, at least one metal raw material, a chelating agent, and a basic aqueous solution, and then calcining and pulverizing the mixture to be nanosize.

In an exemplary embodiment of the present invention, the metal raw material formed, on the surface portion may be identical to or different from the metal raw material used in preparing the central portion. In addition, more specifically, M1 may be nickel (Ni) salts, M2 may be cobalt (Co) salts, and M3 may be manganese (Mn) salts as the metal raw material of the surface portion, similar to the preparation of the central portion. In addition, the metal raw material may be mixed by adjusting the molar ratio so as to have high capacity characteristics. This molar ratio may be easily adjusted depending on the metal composition of the central portion to be obtained.

In an exemplary embodiment of the present invention, the type and the amount used of a chelating agent and a basic aqueous solution used in the preparation of the compound for forming the surface portion, may be identical to or different from the central portion, and the present invention is not limited thereto.

In an exemplary embodiment of the present invention, the step b) may be carried out by a co-precipitation method as in step a). Here, average residence time, pH, reaction time, or the like of the metal salt solution may be identical to or different from the step a), and the present invention is not limited thereto. In addition, the drying of the precipitate obtained through the reactor and mixing of the lithium raw material may also be carried out under the same conditions as in step a). The ratio of the lithium raw material and the metal composite oxide (a precipitate) is preferably 1:1, but is not limited thereto.

The compound for forming the surface portion obtained from, the step b) may be pulverized to have a size of several nanometers using an air jet mill. The electrical conductivity of the cathode active material thus prepared may be improved.

Next, in the step c), the surface portion may be formed on the surface of the central portion by mixing the central portion obtained from the step a) and the compound for forming the surface portion obtained from the step b). In the step c), the method of forming the surface portion is not limited. For example, the central portion and the compound for forming the surface portion may be charged into a high-speed dry coater and mixed at a speed of 1,000 to 50,000 rpm. The compound for forming the surface portion may be applied on the surface of the central portion, while being surrounded with a constant thickness through mixing. In addition, in step c), the thickness of the surface portion on which the central portion is coated, may be adjusted by adjusting retention time, temperature, or rotation speed in the reactor.

The obtained compound may be subjected to heat treatment as in the step d) to form a structure where a concentration of the metal in the central portion is different from that the metal in the surface portion. Here, the heat-treatment temperature is not limited to the present invention, and may be carried out at 300 to 1,000° C. The atmosphere may also be an oxidizing atmosphere such as air or oxygen. In addition, the neat treatment may be carried out for 10 to 30 hours. Pre-calcining may be carried out by maintaining the obtained compound at 150 to 800° C. for 5 to 20 hours before the heat treatment process, or annealing may be carried out at 600 to 800° C. for 10 to 20 hours after the neat treatment process.

In an exemplary embodiment of the present invention, when the structure of the lithium-metal oxide includes the central portion, the boundary portion and the surface portion, the lithium-metal oxide may be prepared in the same method as the lithium-metal oxide having a two-layer structure of the central portion and the surface portion. That is, when the boundary portion is coated on the central portion, the composition for forming the boundary portion may be first pulverized, the pulverized composition may be charged into the reactor, stirred and coated, and then the surface portion may be carried out on the surface of the boundary portion with the same method.

The electrolyte of the lithium secondary battery according to an exemplary embodiment, of the present invention is generally stable in the range of temperature −20° C. to 60° C. and maintains electrochemically stable characteristics even at a voltage of 4.35 V or more, and thus may be applied to all lithium secondary batteries such as a lithium ion battery and a lithium polymer battery.

In particular, the electrolyte of the lithium secondary battery according to an exemplary embodiment, of the present invention may be driven at a voltage of 4.20 V or more, preferably voltage of 4.30 V or more, and more preferably voltage of 4.35 V or more, based on the cathode potential.

The lithium secondary battery according to an exemplary embodiment of the present invention exhibits a capacity retention rate of 85% or more, preferably 90% or more, and more preferably 95% or more, during a lifetime.

The lithium secondary battery according to an exemplary embodiment of the present invention exhibits a discharge capacity retention rate of 60% or more, preferably 70% or more, more preferably 80% or more, and still more preferably 90% or more when left for a long time at a nigh temperature.

The lithium secondary battery according to an exemplary embodiment of the present invention exhibits a discharge output retention rate of 65% or more, preferably 75% or more, more preferably 80% or more, still more preferably 90% or more, and further still more preferably 95% or more when left for a long time at a high temperature.

Hereinafter, Inventive Example and Comparative Examples will be described. However, the inventive Example is only an exemplary embodiment of the present invention, and the present invention is not limited to the Inventive Example. It is assumed that the lithium salt is all dissociated so that the concentration of the lithium ion is 1 mol (1M), and a base electrolyte may be formed by dissolving a corresponding amount of the lithium salt such as LiPF₆ in a base solvent so that the lithium salt is a concentration of 1 mol (1M).

### EXAMPLE 1

### Preparation of 1,2-bis ((difluorophosphanyl)-oxy)ethane (ethyl 1,2-bis-difluorophosphite, or F₂PO (CH₂)₂OPF₂ (Hereinafter, Referred to as “BDFPOE”))

Step 1: Preparation of 1,2-bis((dichlorophosphanyl)-oxy)ethane (ethyl 1,2-bis-dichlorophosphite, or Cl₂PO (CH₂)₂OPCl₂)

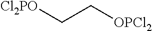

To a 250 ml flask was added 100 ml of tetrahydrofuran 31.23 ml (0.35 mol) of trichlorophosphine (PCl₃) was added thereto, the mixture was stirred for 30 minutes, and then cooled to a low temperature of about 0° C. using ice water. 10 g (0.16 mol) of ethylene glycol was slowly added dropwise thereto for 30 minutes. After all ethylene glycol was added, the temperature was raised to room temperature and stirred for 3 hours. The reaction mixture was vacuum reduced to remove volatiles, and then 1.10 g (4.16 mmol) of the final product, 1,2-bis(dichlorophosphanyl) oxyethane, which is a clear liquid at an external heating temperature of 180° C. under a reduced pressure condition of 10 torr, was obtained in 2.6% yield. 2-chloro-1,3,2-dioxaphospholane (C₂H₄ClO₂P), which is a ring-type material, was mainly prepared as a main product, and a title compound was prepared as a by-product.

¹H NMR (500 MHz, C₆D₆) 3.4 (d, 4H)

Step 2: Preparation of BDFPOE

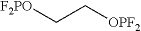

To a 50 ml flask was added 0.11 g (0.61 mmol) of antimony trifluoride under a nitrogen atmosphere. The temperature was lowered to a low temperature of about 0° C. in order to prevent heat generation, composite damage and yield reduction of the final product, or the like, due to abrupt reaction. 1.10 g (4.16 mmol) of 1,2-bis(dichlorophosphanyl) oxyethane prepared in the above step 1 was slowly added dropwise thereto. As a reaction proceeded, the resulting mixture turned into brown or dark brown liquid. The reaction was allowed to proceed sufficiently at room temperature for 12 hours, and then the reaction mixture was heated and purified. That is, when an external heating temperature approached approximately 50° C., a clear liquid began to distill and 0.16 g (0.83 mmol) of BDFPOE, the final product, was obtained in 20% yield.

¹H NMR (500 MHz, C₆D₆) 3.4 (d, 4H);

³¹P NMR (500 MHz, C₆D₆) 110 ppm (t, 2P);

¹⁹F NMR (500 MHz, C₆D₆) −46 (s, F), −49 ppm (s, F)

### EXAMPLE 2

### Preparation of pentyldifluorophosphite (or CH₃ (CH₂)₄OPF₂) (Hereinafter, Referred as to “PDFP”))

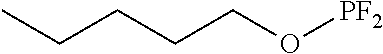

Step 1: Preparation of Pentyldichlorophosphite (or CH₃ (CH₂)₄OPCl₂)

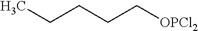

To a 500 ml flask was added 200 ml of tetrahydrofuran. 56 ml (0.57 mol) of trichlorophosphine (PCl₃) was added thereto, the resulting mixture was stirred for 30 minutes, and then cooled to a low temperature of about 0° C. using ice water. 50 g (0.57 mol) of pentane-1-alcohol was slowly added dropwise thereto for 30 minutes, and then the resulting mixture was stirred for 3 hours while raising temperature to room temperature. The reaction mixture was vacuum reduced to remove volatiles. The resulting mixture was analyzed using nuclear magnetic resonance equipment to identify residual materials and final products. 75 g (0.40 mol) of final product, pentyl dichlorophosphite obtained after pressure reduction, was obtained 70% yield with almost 100% purity.

¹H NMR (500 MHz, C₆D₆) 0.94 (m, 3H), 1.00-1.40 (m, 6H), 3.80 (m, 2H) ppm

Step 2: Preparation of PDFP

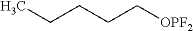

To a 100 ml flask was added 20 g (0.11 mol) of antimony trifluoride under a nitrogen atmosphere. The temperature was lowered to a low temperature of about 0° C. in order to prevent heat generation, composite damage, yield reduction of the final product, or the like, due to abrupt reaction. 30 g (0.16 mol) of pentyldichlorophosphite prepared in the above step 1 was slowly added dropwise thereto. As the reaction proceeded, the reaction mixture turned into a brown or dark brown liquid. The reaction was allowed to proceed sufficiently at room temperature for 12 hours, and then the reaction mixture was heated and subjected to vacuum distillation for purification. That is, when an external heating temperature approached approximately 130° C., a clear liquid began to distill and 12 g (0.077 mol) of PDFP, the final product, was obtained in approximately 4 8% yield.

¹H NMR (500 MHz, C₆D₆) 0.74 (m, 3H), 1.00-1.20 (m, 4H), 1.30 (m, 2H), 3.67 (q, 2H) ppm;

³¹P NMR (500 MHz, C₆D₆) 110 ppm (t, 2P);

¹⁹F NMR (500 MHz, C₆D₆) −46 (s, F), −50 ppm (s, F)

### EXAMPLES 3 to 14

The total composition of the cathode active material containing lithium-metal oxide was LiNi_{0.8}Co_{0.1}Mn_{0.1}O₂, the composition of the first central portion was LiNi_{0.83}Co_{0.1}Mn_{0.07}O₂ (positions 1 to 4 in Table 1, error range: ±0.01 molar ratio), the composition of the boundary portion was LiNi_{0.5}Co_{0.1}Mn_{0.1}O₂ (positions 1 to 5 in Table 1, error range: ±0.01 molar ratio), the composition of the surface portion was LiNi_{0.78}Co_{0.1}Mn_{0.12}O₂ (positions 6 to 13 in Table 1, error range: ±0.01 molar ratio), and a lithium-metal oxide (CAM 1) having a concentration gradient from the central portion to the surface portion was used. Here, the composition of the lithium-metal oxide was |a1−a2|=|c1−c2|=0.03, |a2−a3|=|c2−c3|=0.02, |a1−a3|=c1−c3|=0.05, L₁/L=0.25, L₂/L=0.08.

Here, the concentration gradient of the metal used in the lithium-metal oxide is shown in the following Table 1, and the concentration measurement position is the same as that shown in FIG. 1. The measurement positions were measured at interval of 0.4 μm from the center of the particle for the lithium-metal oxide particle having a radius of 4.8 μm.

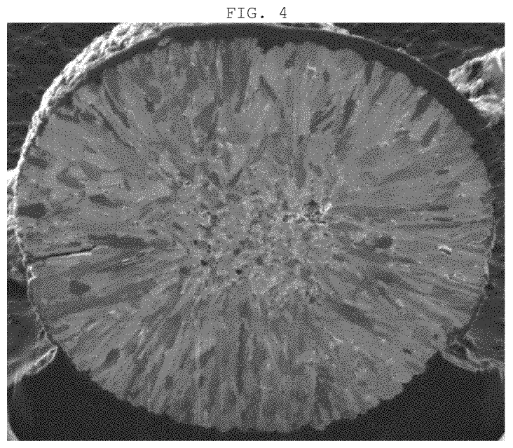

Cross-sectional SEM image of the lithium-metal oxide particles corresponding to Examples 3 to 14 is shown in FIG. 4.

TABLE 1

| Position | Ni (wt %) | Co (wt %) | Mn (wt %) |
|---|---|---|---|
| 1 | 0.830 | 0.100 | 0.070 |
| 2 | 0.831 | 0.101 | 0.068 |
| 3 | 0.829 | 0.100 | 0.071 |
| 4 | 0.830 | 0.100 | 0.070 |
| 5 | 0.800 | 0.099 | 0.101 |
| 6 | 0.780 | 0.100 | 0.120 |
| 7 | 0.780 | 0.100 | 0.120 |
| 8 | 0.780 | 0.101 | 0.119 |
| 9 | 0.781 | 0.100 | 0.119 |
| 10 | 0.779 | 0.101 | 0.120 |
| 11 | 0.780 | 0.100 | 0.120 |
| 12 | 0.781 | 0.099 | 0.120 |
| 13 | 0.780 | 0.100 | 0.120 |

The cathode active material, polyvinylidene fluoride (PVDF) having a weight average molecular weight of 750,000 as a binder, and denka black (Manufacturer: Denka, Japan, product name: Denka Black) as a conductive material were mixed at the weight ratio of 92:5:3, and then dispersed in N-methyl-2-pyrrolidone to prepare a cathode slurry. The slurry was applied on an aluminum foil having a thickness of 20 μm, and then dried and rolled to prepare a cathode.

A natural graphite (d002, 3.358 Å) as an anode active material, KS6, which is a conductive material of a flake type, as a conductive material, styrene-butadiene rubber (SBR) as a binder, and carboxymethyl cellulose (CMC) as a thickener were mixed at the weight ratio of 92:5:1:1, and then dispersed in water to prepare an anode active material slurry. The slurry was applied on a copper foil having a thickness of 15 μm, and then dried and rolled to prepare an anode.

A cathode plate and an anode plate were stacked by notching, respectively, a separator (PE 25 μm) was inserted between the cathode plate and the anode plate to form a cell, and each of a cathode tab portion and an anode tab portion was welded. An assembly including welded cathode/separator/anode was inserted into a pouch with a thickness of 8 mm, a width of 60 mm, and a length of 90 mm, and three surfaces except for an electrolyte injection portion were sealed. Here, a portion having a tap is included in a sealing portion.

An electrolyte was prepared by dissolving LiPF₆ in a mixed solvent of ethylene carbonate (EC):ethyl methyl carbonate (EMC):diethyl carbonate (DEC) having the volume ratio of 25:45:30 to form a 1.0 M solution, as a basic electrolyte (1M LiPF₆, EC/EMC/DEC=25:45:30), further mixed with the components shown in the following Table 2. Then, the resulting mixture was charged into a pouch, the electrolyte injection portion was sealed and impregnated for 12 hours to prepare a lithium secondary battery.

Then, pre-charging was conducted for 36 minutes at a current (2.5 Å) corresponding to 0.25C. The battery was degassed after 1 hour, aged for 24 hours, and then formation-charged/discharged (charging condition CC-CV 0.2C 4.2V 0.05C CUT-OFF, discharging condition CC 0.2C 2.5V CUT-OFF). Thereafter, standard charging/discharging was conducted.

### EXAMPLES 15 to 18

The lithium secondary batteries were manufactured in the same manner as in Examples 3 to 14 except that the lithium-metal oxide was prepared as follows.

The total composition of the lithium-metal oxide was LiNi_{0.88}Co_{0.09}Mn_{0.03}O₂ and a lithium-metal oxide (CAM2) having a concentration gradient from the central portion to the surface portion was used.

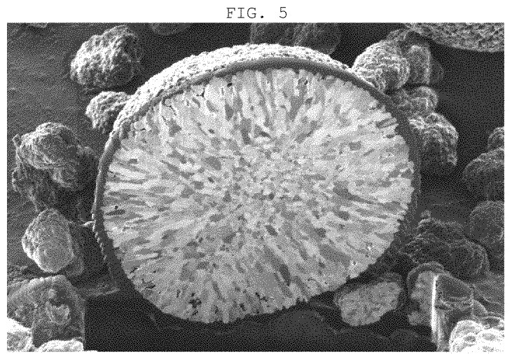

The cross-sectional SEM image of the lithium-metal oxide particle corresponding to Examples 15 to 18 is shown in FIG. 5.

### COMPARATIVE EXAMPLES 1 to 5

The lithium secondary batteries were manufactured in the same manner as in Examples 3 to 14 except that LiNi_{0.8}Co_{0.1}Mn_{0.03}O₂ (NCM811) having a homogeneous composition as a whole particle was used instead of CAM1 as the cathode active material.

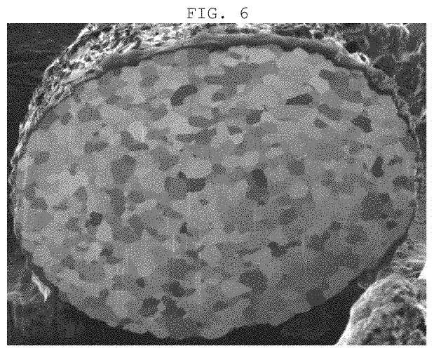

The cross-sectional SEM image of the lithium-metal oxide particle corresponding to Comparative Examples 1 to 5 is shown in FIG. 6.

[Experimental Method]

1. Measurement of capacity retention rate during lifetime (1C/1C)

After charging at 4.2V, 16 A CC-CV at room temperature, the discharge was repeated 500 times up to 2.5V at a current of 16 A. The capacity retention rate during the lifetime was calculated by dividing a 500th discharge capacity by a 1st discharge capacity.

2. Measurement of discharge capacity maintenance rate at the time of storing and leaving cell at high temperature (relative to discharge capacity at room temperature)

When the cells charged in the state of SOC95 as compared to the discharge capacity (SOC95) at room temperature (25° C.) were left at 60° C. for 16 weeks, using the batteries manufactured by the examples and the comparative examples, the discharge capacity retention rate after 16 weeks was measured. The results are shown in the following Table 2.

3. Measurement of discharge output maintenance rate at the time of storing and leaving cell at high temperature (relative to discharge output (SOC95) at room temperature (25° C.))

When the cells charged in the state of SOC95 were left at 60° C. for 16 weeks using the batteries manufactured by the Examples and the Comparative Examples, the discharge output retention rate after 16 weeks was measured. The results are shown in the following Table 2.

TABLE 2

| | | | Capacity | After 16 weeks at | |
|---|---|---|---|---|---|
| | | | retention | 60° C. | |
| | | | rate | Discharge | Discharge |
| | | | during | capacity | output |
| | | Cathode | 500^{th} | retention | retention |
| | Electrolyte | active | lifetime | rate | rate |
| | composition | material | (%) | (%) | (%) |
| Example 3 | Basic electrolyte | CAM1 | 80.9 | 54 | 55 |
| Example 4 | Basic electrolyte + | CAM1 | 87.1 | 60 | 65 |
| | WCA-2 1.0 wt % +LiBOB | | | | |
| | 1.0 wt % + PS 1.0 wt % | | | | |
| Example 5 | Basic electrolyte + | CAM1 | 90.3 | 78 | 82 |
| | BDFPOE 1.0 wt % | | | | |
| Example 6 | Basic electrolyte + | CAM1 | 90.2 | 79 | 83 |
| | BDFPOE 1.5 wt % | | | | |
| Example 7 | Basic electrolyte + | CAM1 | 87.5 | 74 | 79 |
| | PDFP 1.0 wt % | | | | |
| Example 8 | Basic electrolyte + | CAM1 | 88.1 | 75 | 80 |
| | PDFP 1.5 wt % | | | | |
| Example 9 | Basic electrolyte + | CAM1 | 92.0 | 85 | 88 |
| | BDFPOE 1.0 wt % + | | | | |
| | WCA-2 1.0 wt % | | | | |
| Example 10 | Basic electrolyte + | CAM1 | 90.4 | 88 | 90 |
| | BDFPOE 1.0 wt % + | | | | |
| | LiBOB 1.0 wt % | | | | |
| Example 11 | Basic electrolyte + | CAM1 | 90.2 | 90 | 92 |
| | BDFPOE 1.0 wt % + PS | | | | |
| | 1.0 wt % | | | | |
| Example 12 | Basic electrolyte + | CAM1 | 92.9 | 89 | 91 |
| | BDFPOE 1.0 wt % + | | | | |
| | WCA-2 1.0 wt % +LiBOB | | | | |
| | 1.0 wt % | | | | |
| Example 13 | Basic electrolyte + | CAM1 | 92.1 | 90 | 93 |
| | BDFPOE 1.0 wt % + | | | | |
| | WCA-2 1.0 wt % + PS 1.0 | | | | |
| | wt % | | | | |
| Example 14 | Basic electrolyte + | CAM1 | 95.3 | 92 | 95 |
| | BDFPOE 1.0 wt % + | | | | |
| | WCA-2 1.0 wt % +LiBOB | | | | |
| | 1.0 wt % + PS 1.0 wt % | | | | |
| Example 15 | Basic electrolyte | CAM2 | 79.8 | 34 | 38 |
| Example 16 | Basic electrolyte + | CAM2 | 90.0 | 85 | 82 |
| | BDFPOE 1.0 wt % | | | | |
| Example 17 | Basic electrolyte + | CAM2 | 86.3 | 80 | 76 |
| | PDFP 1.0 wt % | | | | |
| Example 18 | Basic electrolyte + | CAM2 | 94.1 | 90 | 93 |
| | BDFPOE 1.0 wt % + | | | | |
| | WCA-2 1.0 wt % +LiBOB | | | | |
| | 1.0 wt % + PS 1.0 wt % | | | | |
| Comparative | Basic electrolyte | NCM811 | 70.0 | 54 | 56 |
| Example 1 | | | | | |
| Comparative | Basic electrolyte + | NCM811 | 76.1 | 54 | 56 |
| Example 2 | WCA-2 1.0 wt % | | | | |
| Comparative | Basic electrolyte + | NCM811 | 79.4 | 60 | 65 |
| Example 3 | WCA-2 1.0 wt % +LiBOB | | | | |
| | 1.0 wt % + PS 1.0 wt % | | | | |
| Comparative | Basic electrolyte + | NCM811 | 79.3 | 67 | 73 |
| Example 4 | BDFPOE 1.0 wt % | | | | |
| Comparative | Basic electrolyte + | | | | |
| Example 5 | BDFPOE 1.0 wt % + | NCM811 | 81.9 | 73 | 80 |
| | WCA-2 1.0 wt % +LiBOB | | | | |
| | 1.0 wt % +PS 1.0 wt % | | | | |

Basic electrolyte: 1MLiPF₆, EC/EMC/DEC = 25:45:30
WCA-2: Lithium-difluoro (Oxalato) phosphate
LiBOB: Lithium-bis (Oxalato) Borate
PS: 1,3-propane sultone

As shown in Table 2, it may be appreciated that the lithium secondary batteries of Examples 5 to 14, 16 to 18, and Comparative Examples 4 and 5 which use the electrolyte according to an exemplary embodiment of the present invention, including the compound of Chemical Formula 1, have a high capacity retention rate as well as a high discharge capacity retention rate and a discharge output retention rate even after 16 weeks at 60° C., and thus have high, temperature storage characteristics.

In addition, it may be confirmed that the electrolytes of Examples 9 to 14, 18, and Comparative Examples 3 to 5 of the present invention further include at least one additive selected from the compound represented by Chemical Formula 1 according to the present invention, lithium bis oxalato borate (LiB(C₂O₄)₂, LiBOB), lithium difluorooxalato phosphate (LiPF₂(C₂O₄)₂, WCA-2), and propane sultone (PS), thereby improving high temperature storage characteristics and lifetime characteristics.

Specifically, the results of Examples 5 to 14 exhibit that when using BDFPOE and PDFP, a lifetime performance, a high temperature storage capacity retention rate, and an output retention rate are improved. It is confirmed that the above-mentioned characteristics are particularly improved, as compared to Comparative Examples 1 to 5.

The results of Examples 15 to 18 also exhibit a lifetime performance, a high temperature storage capacity retention rate, and an output retention rate which are equivalent to or improved as compared to those of Examples 3 to 14, and particularly exhibit a remarkable improvement in a high temperature storage capacity retention rate and an output retention rate. It shows that in the case of lithium-metal oxides having a difference in metal concentration between the central portion and the surface portion, the addition of BDFPOE and PDFP is more effective, and in addition, in the case of lithium-metal oxides having a high Ni content, it is particularly effective in improving high temperature storage characteristics. It is confirmed that since the higher contents of Ni are, the more oxidation of the electrolyte occurs on the surface of the cathode active material in a charge state, this will be effective in improving the degradation in high temperature storage performance, which causes a severe problem, and the electrolyte according to an exemplary embodiment of the present invention enhances the surface stabilization of the cathode active material and thus this will be highly effective in improving the lifetime and high temperature storage performance of an unstable high-Ni-containing active material due to a high surface oxidation number.

The lithium secondary battery of the present invention has excellent lifetime characteristics as well as excellent high temperature characteristics without lowering output even under a high voltage.

In addition, the lithium secondary battery according to the present invention has an excellent capacity recovery at a high temperature as well as a high temperature storage stability.

In addition, the lithium secondary battery according to the present invention has an excellent high temperature storage stability and lifetime characteristics while maintaining good basic performance such as high-efficiency charging/discharging characteristics.

While exemplary embodiments have been shown and described above, it will be apparent to those skilled in the art that modifications and variations could be made without departing from the scope of the present invention as defined by the appended claims.

What is claimed is:

1. A lithium secondary battery comprising:
a cathode;
an anode; and
a non-aqueous electrolyte,
wherein the cathode includes a cathode active material containing a lithium-metal oxide,
the electrolyte includes a lithium salt, a non-aqueous organic solvent, and a compound of the following Chemical Formula 1, and
the lithium-metal oxide includes at least one metal of which a concentration at a central portion of the lithium-metal oxide particle is different from that at a surface portion of the lithium-metal oxide particle. 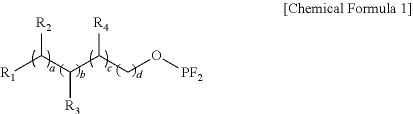
wherein, R₁ is hydrogen or C1-C4alkyl, R₂ to R₄ are each independently hydrogen, C1-C4alkyl, or -OPF₂, a, b, and c are each independently an integer of 0 to 4, and d is an integer of 1 to 3, and when a, b, and c are 2 or more, R₂ to R₄ are identical to or different from each other.

2. The lithium secondary battery of claim 1, wherein in Chemical Formula 1, R₁ is hydrogen or C1-C4alkyl, R₂ to R₄ are each independently hydrogen or -OPF₂, and d is an integer of 1 to 2.

3. The lithium secondary battery of claim 1, wherein R₂ is hydrogen or -OPF₂, and R₃ and R₄ are hydrogen.

4. The lithium secondary battery of claim 1, wherein the compound of Chemical Formula 1 is represented by the following Chemical Formula 2: 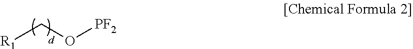
wherein, R₁ is hydrogen or C1-C4alkyl, and d is an integer of 1 to 3.

5. The lithium secondary battery of claim 1, wherein the compound of Chemical Formula 1 is represented by the following Chemical Formula 3: 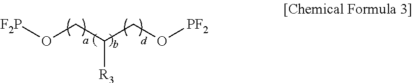
wherein R₃ is hydrogen, C1-C4alkyl, or -OPF₂, a and b are each independently an integer of 0 to 4, and d is an integer of 1 to 3, and when b is 2 or more, R₃ is identical to or different from each other.

6. The lithium secondary battery of claim 1, wherein the compound of Chemical Formula 1 is any one or two or more selected from the following compounds.

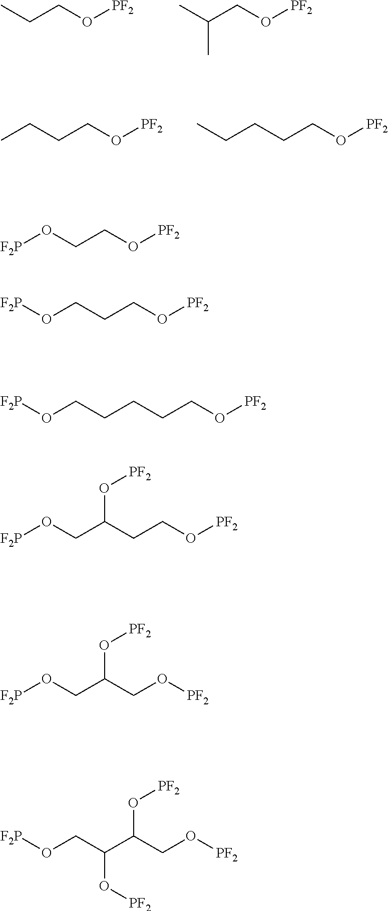

7. The lithium secondary battery of claim 1, wherein the compound of Chemical Formula 1 is the following compound.

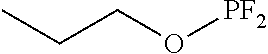

8. The lithium secondary battery of claim 1, wherein the compound of Chemical Formula 1 is the following compound.

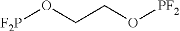

9. The lithium secondary battery of claim 1, wherein the compound of Chemical Formula 1 is included in an amount of 0.1 to 5 wt % relative to the total weight of the electrolyte.

10. The lithium secondary battery of claim 1, wherein the electrolyte further includes any one or two or more selected from lithium bisoxalatoborate, lithium dioxalatofluorophosphate and propanesultone as additional additives.

11. The lithium secondary battery of claim 1, wherein the lithium-metal oxide includes any one or both of at least one first metal having a lower concentration at the surface portion of the lithium-metal oxide particle than at the central portion of the particle and at least one third metal having a higher concentration at the surface portion of the particle than at the central portion of the particle.

12. The lithium secondary battery of claim 11, wherein the lithium-metal oxide includes a boundary portion between the central portion and the surface portion, and
when the lithium-metal oxide includes the first metal, the concentration of the first metal at the boundary portion is lower than that of the first metal at the central portion and/or is higher than that of the first metal at the surface portion, and
when the lithium-metal oxide includes the third metal, the concentration of the third metal at the boundary portion is higher than that of the third metal at the central portion and/or is lower than that of the third metal at the surface portion.

13. The lithium secondary battery of claim 12, wherein the boundary portion includes a plurality of boundary layers, the plurality of boundary layers having a concentration difference in the first metal and/or the third metal between the central portion and a boundary layer adjacent to the central portion, between two adjacent boundary layers, and/or between the surface portion and a boundary layer adjacent to the surface portion, depending on a tendency of the concentration difference in the first metal and/or the third metal between the central portion and the surface portion.

14. The lithium secondary battery of claim 11, wherein when the lithium-metal oxide includes the first metal, the first metal includes at least one metal having at least one section in which a concentration continuously decreases from the central portion of the particle toward the surface portion of the particle and when the lithium-metal oxide includes the third metal, the third metal includes at least one metal having at least one section in which the concentration continuously increases from the central portion of the particle toward the surface portion of the particle.

15. The lithium secondary battery of claim 11, wherein the lithium-metal oxide further includes at least one second metal having a constant concentration throughout the particle.

16. The lithium secondary battery of claim 15, wherein the lithium-metal oxide particle includes a central portion represented by Chemical Formula 5 and a surface portion represented by Chemical Formula 6:
Liₓ₁M1ₐ₁M2_{b1}M3_{c1}O_{y1} [Chemical Formula 5]
Liₓ₃M1ₐ₃M2_{b3}M3_{c3}O_{y3} [Chemical Formula 6]
wherein M1, M2, and M3 are the first metal, the second metal, and the third metal, respectively, 0<x1≤1.1, 0<x3≤1.1, 0≤a1≤1, 0≤a3≤1, 0≤b1≤1, 0≤b3≤1, 0≤c1≤1, 0≤c3≤1, 0≤a1+b1+c1≤1, 0≤a3+b3+c3≤1, a1≤a3, b1=b3, c1≤c3, and y1 and y3 are determined so that the oxidation number of the oxide is 0, depending on the oxidation numbers of Li, M1, M2, and M3, except that a1=a3 and c1=c3.

17. The lithium secondary battery of claim 15, wherein the lithium-metal oxide particle includes a central portion represented by Chemical Formula 5, a surface portion represented by Chemical Formula 6, and a boundary portion represented by Chemical Formula 7 and positioned between the central portion and the surface portion:
Liₓ₁M1ₐ₁M2_{b1}M3_{c1}O_{y1} [Chemical Formula 5]
Liₓ₃M1ₐ₃M2_{b3}M3_{c3}O_{y3} [Chemical Formula 6]
Liₓ₂M1ₐ₂M2_{b2}M3_{c2}O_{y2} [Chemical Formula 7]
wherein M1, M2, and M3 are the first metal, the second metal, and the third metal, respectively, 0<x1≤1.1, 0<x2≤1.1, 0<x3≤1.1, 0≤a1≤1, 0≤a2≤1, 0≤a3≤1, 0≤b1≤1, 0≤b2≤1, 0≤b3≤1, 0≤c1≤1, 0≤c2≤1, 0≤c3≤1, 0<a1+b1+c1≤1, 0<a2+b2+c2≤1, 0<a3+b3+c3≤1, a1≥a2≥a3, b1=b2=b3, c1≥c2≥c3, and y1 to y3 are determined so that the oxidation number of the oxide is 0, depending on the oxidation numbers of Li, M1, M2, and M3, except that a1=a2 and c1=c2 and that a2=a3 and c2=c3.

18. The lithium secondary battery of claim 15, wherein the first metal, the second metal, and the third metal include Ni, Co, and Mn, respectively.

19. The lithium secondary battery of claim 16, wherein 0.6≥a1≥1.

20. The lithium secondary battery of claim 16, wherein a1−a3≥0.2.
